(19) United States
(12) Patent Application Publication
(10) Pub. No.: US 2016/0032052 A1
(43) Pub. Date: Feb. 4, 2016

(54) PROCESS FOR MANUFACTURING POLYAMIDE

(71) Applicant: SUMITOMO BAKELITE COMPANY LIMITED, Shinagawa-ku (JP)

(72) Inventors: Toshihiko KATAYAMA, Nishinomiya-shi (JP); Jun OKADA, Kobe-shi (JP); Ritsuya KAWASAKI, Kobe-shi (JP); Hideo UMEDA, Kobe-shi (JP)

(73) Assignee: SUMITOMO BAKELITE COMPANY LIMITED, Shinagawa-ku (JP)

(21) Appl. No.: 14/814,631

(22) Filed: Jul. 31, 2015

Related U.S. Application Data
(60) Provisional application No. 62/031,999, filed on Aug. 1, 2014.

(51) Int. Cl. C08G 69/32

(52) U.S. Cl. CPC C08G 69/32

(57) ABSTRACT

In one or a plurality of embodiments, a process for manufacturing polyamide, with a reduced use of an amide-based solvent in synthesis, is provided. In one or a plurality of embodiments, provided is a process for manufacturing polyamide, including steps (a) to (c): (a) dissolving diacid dichloride in a non-amide-based organic solvent; (b) adding diamine to a solution obtained in the step (a) and reacting the diacid dichloride with the diamine so as to generate polyamide; and (c) adding a trapping reagent capable of trapping hydrochloric acid, at any time at least before the step (b), at the same time of starting the step (b), or during the step (b).

### CROSS-REFERENCE TO RELATED APPLICATION

The disclosure is based upon and claims priority from U.S. Provisional Application Ser. No. 62/031,999, filed on Aug. 1, 2014, the disclosure of which is hereby incorporated by reference herein in its entirety.

### TECHNICAL FIELD

The present disclosure relates to a process for manufacturing polyamide.

### BACKGROUND

As transparency is required for display elements, glass substrates using glass plates have been used as substrates for the elements. However, for display elements using glass substrates, problems such as being heavy in weight, breakable and unbendable have been pointed out at times. Thus, use of a transparent resin film instead of a glass substrate has been proposed. For example, polycarbonates, which have high transparency, are known as transparent resins for use in optical applications. However, their heat resistance and mechanical strength may not be sufficient to be used for manufacturing display elements. On the other hand, examples of heat resistant resins include polyimides. However, typical polyimides are brown-colored, and thus it may not be suitable for use in optical applications. As polyimides with transparency, those having a ring structure are known. However, the problem with such polyimides is that they have poor heat resistance.

Patent document 1 or 2 relates to aromatic polyamide films for transparent flexible substrates applied to microelectronic equipment. These documents disclose a method for synthesizing polyamide, including: dissolving diamine in an amide-based solvent (DMAc) and then adding diacid dichloride so as to form a gel; later adding PrO (propylene oxide) thereto, and pulverizing the gel so as to obtain a homogeneous polyamide solution.

### PATENT DOCUMENTS

[Patent document 1] WO2012/129422
[Patent document 2] JP 2014-508851

### SUMMARY

Recently, there has been a concern on the environmental loads caused by amide-based solvents. Therefore, the present disclosure provides, in one or a plurality of embodiments, a process for manufacturing polyamide, with a reduced use of an amide-based solvent in synthesis.

In one or a plurality of embodiments, the present disclosure relates to a process for manufacturing polyamide, including steps (a) to (c) below:

(a) dissolving diacid dichloride in a non-amide-based organic solvent;

(b) adding diamine to a solution obtained by the step (a) and reacting the diacid dichloride with the diamine so as to generate polyamide; and

(c) adding a trapping reagent capable of trapping hydrochloric acid, at any time at least before the step (b), at the same time of starting the step (b), or during the step (b).

In one or a plurality of embodiments, the present disclosure relates to a polyamide solution manufactured by a manufacturing process according to the present disclosure, and relates to a process for manufacturing a display element, an optical element, an illumination element or a sensor element, comprising steps (I) and (II) below:

(I) applying a polyamide solution on a base to form a film, the solution being obtained or obtainable by the process according to the present disclosure, and

(II) forming the display element, the optical element, the illumination element, or the sensor element on a surface of the polyamide film;

wherein the base or the surface of the base is formed of glass or silicon wafer.

According to the present disclosure, in one or a plurality of embodiments, it is possible to provide a process for manufacturing polyamide with a reduced use of an amide-based solvent in a polymerization reaction of polyamide.

### BRIEF DESCRIPTION OF DRAWINGS

FIG. 1 is a schematic view for explaining a process for manufacturing an OLED element or a sensor element according to one embodiment.

FIG. 2 is a schematic cross-sectional view showing a configuration of an organic EL element 1 according to one embodiment.

FIG. 3 is a schematic cross-sectional view showing a sensor element 10 according to one embodiment.

### DETAILED DESCRIPTION

In a case of dissolving diamine in an amide-based solvent and then adding diacid dichloride for a reaction to synthesize polyamide, hydrochloric acid generated due to a polymerization reaction and the diamine form hydrochloride that causes white turbidity or gelation, thereby delaying the polymerization reaction. For avoiding this, an agent to trap hydrochloric acid (for example, propylene oxide (PrO), hereinafter, expressed also as “trapping reagent”) is added to the reaction solution before, at the same time, or after addition of the diacid dichloride.

The present inventors studied use of non-amide-based solvent in place of the amide-based solvent. When diamine is dissolved in a non-amide-based solvent and then diacid dichloride is added thereto, similarly to the case of an amide-based solvent, hydrochloric acid generated due to the polymerization reaction and the diamine form hydrochloride thereby causing white turbidity or gelation, which delays the polymerization reaction. In light of this, the inventors considered use of a trapping reagent.

As a first trial with regard to the order, diamine was dissolved in a non-amide-based solvent and then a trapping reagent was added thereto, to which diacid dichloride was added. However, according to this procedure, a polymerization reaction of polyamide did not start. The reason is considered as follows. Namely, unlike the case of an amide-based solvent, in the non-amide-based solvent, the trapping reagent added prior to the diacid dichloride reacts or is stabilized with the diamine.

In a next trial, diamine was dissolved in a non-amide-based solvent, and then diacid dichloride was added. In this trial, hydrochloride formed by the reaction between the diamine and the hydrochloric acid generated due to the polymerization reaction resulted in a state of white turbidity or gelation. To this white turbidity or gel, a trapping reagent was added. At this time, the trapping reagent did not react or was not stabilized with the diamine, but the trapping reagent trapped the hydrochloric acid. As a result, the white turbidity and the gel became transparent, the polymerization reaction was promoted, and the viscosity was increased. In this method, the reaction solution is once becomes whitish or gelate, but finally it becomes transparent. And thus, it is possible to promote the polyamide synthesis reaction without using an amide-based solvent. However, another problem occurred. Namely, the polyamide solution manufactured according to this method was colored yellowish.

It has been found that the problem of white turbidity or gelation of the reaction solution can be solved in the following manner. Namely, by using, as the solvent, a non-amide-based organic solvent containing a small amount of amide-based organic solvent, the white turbidity and the gelation can be suppressed, and the polymerization reaction can be homogenized. However, there still remains the problem that the manufactured polyamide solution is colored yellowish.

The present disclosure is based on a finding that white turbidity and gelation can be suppressed to achieve a homogeneous polymerization reaction and also yellowish coloring can be suppressed, without use of an amide-based solvent, according to the method of dissolving diacid dichloride in a non-amide-based solvent and adding diamine thereto for the purpose of polymerization reaction.

Namely, in one or a plurality of embodiments, the present disclosure relates to a process for manufacturing polyamide (hereinafter, it is expressed also as a “manufacturing process of the present disclosure), including steps (a) to (c) as mentioned below:

(a) dissolving diacid dichloride in a non-amide-based organic solvent;

(b) adding diamine to a solution obtained by the step (a) and reacting the diacid dichloride with the diamine so as to generate polyamide;

(c) adding a trapping reagent capable of trapping hydrochloric acid, at any time at least before the step (b), at the same time of starting the step (b), or during the step (b).

In one or a plurality of embodiments, the manufacturing process of the present disclosure can exhibit an effect that polyamide can be synthesized without using an amide-based solvent or by reducing the use of an amide-based solvent. Further, in one or a plurality of embodiments, the manufacturing process of the present disclosure can exhibit an effect that polyamide can be synthesized without causing white turbidity or gelation of the reaction solution. It is considered that since either white turbidity or gelation does not occur, the polymerization reaction proceeds more homogeneously. Furthermore, in one or a plurality of embodiments, the manufacturing process of the present disclosure can exhibit an effect that a problem of yellowish coloring can be avoided.

Although the details of the mechanism for suppressing white turbidity or gelation in the manufacturing process of the present disclosure have not been clarified, it is deduced as follows. Namely, formation of hydrochloride between hydrochloric acid generated by a polymerization reaction and diamine in the reaction solution is considered as one cause of the white turbidity or gelation. In the manufacturing process of the present disclosure where diamine is added to the reaction solution in which the diacid dichloride has been dissolved, the diamine serves to the polymerization reaction of polyamide before hydrochloride is formed. As a result, hydrochloride is not formed and thus the white turbidity or gelation can be suppressed. Further, although the details of the mechanism for suppressing yellowish coloring in the manufacturing process of the present disclosure has not been clarified, it is deduced as follows. Namely, the yellowish coloring can be suppressed since the non-amide-based organic solvent and diamine hydrochloride do not coexist. However, there is no necessity of interpreting the present disclosure with limitation to this mechanism.

[Non-Amide-Based Solvent]

In the manufacturing process according to the present disclosure, the non-amide-based solvent used for the polymerization reaction of polyamide, namely, the non-amide-based solvent in the step (a), is a non-protic solvent, in one or a plurality of embodiments. In another one or a plurality of embodiments, from the viewpoint of reducing the use of an amide-based solvent in the polyamide polymerization reaction, γ-butyrolactone, α-methyl-γ-butyrolactone, or a mixture thereof is preferred.

In one or a plurality of embodiments, in the manufacturing process of the present disclosure, a non-amide-based solvent is used alone as the solvent for the polymerization reaction, or any amide-based solvent is not used. Therefore, in the manufacturing process of the present disclosure, synthesis of polyamide can be conducted in the absence of an amide-based solvent.

In one or a plurality of embodiments of the manufacturing process according to the present disclosure, the solvent for the polymerization reaction may contain any other solvent than the non-amide-based organic solvent. In such a case, it is preferable that the content of the non-amide-based organic solvent in the solvent is 90% by mass or more, 95% by mass or more, 98% by mass or more 99% by mass or more, or 99.5% by mass or more.

In one or a plurality of embodiments of the manufacturing process according to the present disclosure, examples of the solvent including a solvent other than a non-amide-based organic solvent may include a non-amide-based solvent containing an amide-based solvent. In one or a plurality of embodiments, examples of the amide-based solvent may include: N,N-dimethylacetamide (DMAc), N-methyl-2-pyrrolidone (NMP), N,N-dimethylformamide (DMF), 3-methoxy-N,N-dimethylpropionamide, 3-butoxy-N,N-dimethylpropanamide, 1-ethyl-2-pyrrolidone, N, N-dimethylpropionamide, N,N-dimethylbutyramide, N,N-diethylacetamide, N,N-diethylpropionamide, 1-methyl-2-piperidinone, and a combination thereof.

[Diacid Dichloride]

The diacid dichloride used in the manufacturing process according to the present disclosure is not limited in particular but it may include any known diacid dichloride that is used and will be used as a monomer for synthesizing a polyamide film. In one or a plurality of embodiments, from the viewpoint of manufacturing polyamide to be used for a polyamide film used in an electronic part such as a display element, an optical element, an illumination element or a sensor element, the diacid dichloride may be selected from the group consisting of

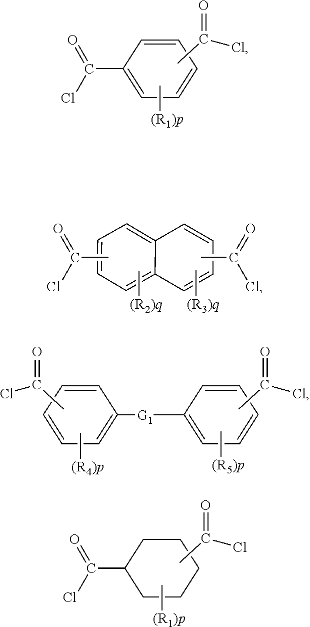

and a combination thereof.

In the above formulae for diacid dichloride, p=4, q=3, and wherein R₁, R₂, R₃, R₄, and R₅ are selected from the group consisting of hydrogen, halogen (fluoride, chloride, bromide, and iodide), alkyl, substituted alkyl such as halogenated alkyl, nitro, cyano, thioalkyl, alkoxy, substituted alkoxy such as a halogenated alkoxy, aryl, or substituted aryl such as halogenated aryl, alkyl ester and substituted alkyl ester such as halogenated alkyl ester, and combinations thereof. It is to be understood that each R₁ can be different, each R₂ can be different, each R₃ can be different, each R₄ can be different, and each R₅ can be different. G₁ is selected from the group consisting of a covalent bond; a CH₂ group; a C(CH₃)₂ group; a C(CF₃)₂ group; a C(CX₃)₂ group, where X is a halogen; a CO group; an O atom; a S atom; a SO₂ group; a Si(CH₃)₂ group; a 9,9-fluorene group; a substituted 9,9-fluorene group; and an OZO group, where Z is an aryl group or a substituted aryl group, such as a phenyl group, a biphenyl group, a perfluorobiphenyl group, a 9,9-bisphenylfluorene group, and a substituted 9,9-bisphenylfluorene group.

Of these, in one or a plurality of embodiments, examples of the diacid dichloride may include: terephthaloyl dichloride, isophthaloyl dichloride, 2,6-naphthaloyl dichloride, 4,4′-biphenyldicarbonyl dichloride, tetrahydro terephthaloyl dichloride, and a combination thereof, from the viewpoint of manufacturing any polyamide to be used for a polyamide film used in an electronic part such as a display element, an optical element, an illumination element, a sensor element or the like.

[Diamine]

The diamine used in the manufacturing process according to the present disclosure is not limited in particular but any known diamine that is used or will be used as a monomer in synthesis of a polyamide film may be employed. In one or a plurality of embodiments, from the viewpoint of manufacturing polyamide to be used for a polyamide film used in an electronic part such as a display element, an optical element, an illumination element, a sensor element or the like, the diamine may be selected from the group consisting of

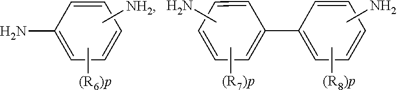

and a combination thereof

In the above formulae for diamine, p=4, and wherein R₆, R₇, and R₈ are selected from the group consisting of hydrogen, halogen (fluoride, chloride, bromide, and iodide), alkyl, substituted alkyl such as halogenated alkyl, nitro, cyano, thioalkyl, alkoxy, substituted alkoxy such as a halogenated alkoxy, aryl, or substituted aryl such as halogenated aryl, alkyl ester and substituted alkyl ester such as halogenated alkyl ester, and combinations thereof. It is to be understood that each R₆ can be different, each R₇ can be different, and each R₈ can be different. G₂ is selected from the group consisting of a covalent bond; a CH₂ group; a C(CH₃)₂ group; a C(CF₃)₂ group; a C(CX₃)₂ group, where X is a halogen; a CO group; an O atom; a S atom; a SO₂ group; a Si(CH₃)₂ group; a 9,9-fluorene group; a substituted 9,9-fluorene group; and an OZO group, where Z is an aryl group or a substituted aryl group, such as a phenyl group, a biphenyl group, a perfluorobiphenyl group, a 9,9-bisphenylfluorene group, and a substituted 9,9-bisphenylfluorene group.

Of these, in one or a plurality of embodiments, from the viewpoint of manufacturing polyamide to be used for a polyamide film used in an electronic part such as a display element, an optical element, an illumination element, a sensor element or the like, examples of the diamine may be 4,4′-diamino-2,2′-bistrifluoromethylbenzidine, 9,9-bis(4-aminophenyl) fluorene, 9,9-bis(3-fluoro-4-aminophenyl) fluorene, 2,2′-bistrifluoromethoxylbenzidine, 4,4′-diamino-2,2′-bistrifluoromethyldiphenyl ether, bis(4-amino-2-trifluoromethylphenyloxyl)benzene, bis(4-amino-2-trifluoromethylphenyloxyl)biphenyl, bis(4-aminophenyl) sulfone (DDS), and a combination thereof.

[Trapping Reagent]

In the present disclosure, a trapping reagent is a compound capable of trapping hydrochloric acid, or a composition containing the compound. There is no particular limitation for the trapping reagent as long as it can trap hydrochloric acid generated in a polymerization reaction, and any trapping reagent that is known and used or will be used can be employed. In one or a plurality of embodiments, the trapping reagent is propylene oxide (PrO). Propylene oxide turns to chloropropanol so as to trap hydrochloric acid.

[Process for Manufacturing Polyamide]

The manufacturing process according to the present disclosure includes the following steps (a) to (c):

(a) dissolving diacid dichloride in a non-amide-based solvent;

(b) adding diamine to a solution obtained in the step (a) and reacting the diacid dichloride with the diamine so as to generate polyamide; and

(c) adding a trapping reagent capable of trapping hydrochloric acid, at any time at least before the step (b), at the same time of starting the step (b), or during the step (b).

In the step (b), the diamine may be added in several parts for the purpose of suppressing abrupt heating in one or a plurality of embodiments. In one or a plurality of embodiments, the diamine to be added may be in a state of powder from the viewpoint of solubility, but it may be a mass or in a state molten by heat. In one or a plurality of non-limiting embodiments, the frequency of addition may be 2 to 10, or 3 to 5. In one or a plurality of embodiments, the reaction system in the step (b) may be cooled, or the temperature may be lowered or kept to be higher than 0° C. and not higher than 50° C., or in the range of 3° C. to 40° C., or 4° C. to 10° C., from the viewpoint of suppressing temperature rise caused by the reaction heat.

In the step (c), in one or a plurality of embodiments, the trapping reagent may be added at any time at least before the step (b), at the same time of starting the step (b), or during the step (b). In one or a plurality of embodiments, from the viewpoint of trapping hydrochloric acid generated due to addition of diamine and promoting the polymerization reaction, the addition is conducted preferably before the step (b) or at the same time of starting the step (b) (i.e., at the same time of the first addition of diamine). In a case of adding the trapping reagent during the step (b), it is preferable that the trapping reagent is added before the hydrochloric acid accumulated inside the system inhibits the polymerization reaction. In one or a plurality of embodiments, the amount of the trapping reagent to be added may be 1.5 to 5.0 times, 2.0 to 4.0 times, or 2.2 to 3.0 times the mole number of the diacid dichloride.

According to the manufacturing process of the present disclosure, in one or a plurality of embodiments, it is possible to synthesize polyamide in a state of being dissolved in a solvent, i.e., as a polyamide solution. Further, according to the manufacturing process of the present disclosure, in one or a plurality of embodiments, it is possible to manufacture the polyamide in the absence of an amide-based solvent. Further, in one or a plurality of embodiments, in the manufacturing process according to the present disclosure, it is possible to manufacture polyamide while suppressing white turbidity and gelation of the reaction solution, with a reduced use of an amide-based solvent. Furthermore, in one or a plurality of embodiments, in the manufacturing process according to the present disclosure, it is possible to manufacture polyamide while suppressing white turbidity and gelation of the reaction solution, and while suppressing yellowish coloring, with a reduced use of an amide-based solvent.

In one or a plurality of embodiments of the present disclosure, from the viewpoint of enhancement of heat resistance property of the polyamide film, the manufacturing process according to the present disclosure further comprises the step of end-capping of one or both of terminal —COOH group and terminal —NH₂ group of the polyamide. The terminal of the polyamide can be end-capped by the reaction of polymerized polyamide with benzoyl chloride when the terminal of polyamide is —NH₂, or reaction of polymerized polyamide with aniline when the terminal of polyamide is —COOH. However, the method of end-capping is not limited to this method.

In one or a plurality of embodiments, the manufacturing process according to the present disclosure can be conducted in the absence of inorganic salt from the viewpoint of using the polyamide solution for manufacturing a display element, an optical element, an illumination element or a sensor element.

In one or a plurality of embodiments in the manufacturing process according to the present disclosure, from the viewpoint of using the polyamide solution in the process for manufacturing a display element, an optical element, an illumination element or a sensor element, the synthesized polyamide in the polyamide solution is precipitated and re-dissolved in a solvent, thereby a polyamide solution dissolved in a solvent afresh can be obtained. The precipitation can be carried out by a typical method. In one or a plurality of embodiments, by adding the polyamide to methanol, ethanol, isopropyl alcohol or the like, it is precipitated, cleaned, and dissolved in a solvent, for example.

[Solvent for Re-Dissolution]

In one or a plurality of embodiments of the present disclosure, from the viewpoint of enhancement of solubility of the polyamide to the solvent, the solvent for re-dissolution may be a polar solvent or a mixed solvent comprising one or more polar solvents. In one or a plurality of embodiments of the present disclosure, from the viewpoint of enhancement of solubility of the polyamide to the solvent and from the viewpoint of enhancing adhesiveness of the polyamide film to a base, the polar solvent may be methanol, ethanol, propanol, isopropanol (IPA), butanol, acetone, methyl ethyl ketone (MEK), methyl isobutyl ketone (MJBK), toluene, cresol, xylene, propylene glycol monomethyl ether acetate (PGMEA), N,N-dimethylacetamide (DMAc) or N-methyl-2-pyrrolidone (NMP), dimethylsulfoxide (DMSO), butyl cellosolve, γ-butyrolactone, α-methyl-γ-butyrolactone, methyl cellosolve, ethyl cellosolve, ethylene glycol monobutyl ether, diethylene glycol monobutyl ether, N,N-dimethylformamide (DMF), 3-methoxy-N,N-dimethylpropionamide, 3-butoxy-N,N-dimethylpropanamide, 1-ethyl-2-pyrrolidone, N,N-dimethylpropanamide, 1-methyl-2-piperidinone, propylene carbonate, and a combination thereof, or a mixed solvent comprising at least one of the solvents.

[Polyamide Solution]

In another aspect, the present disclosure relates to a polyamide solution, namely, a solution containing polyamide manufactured by the manufacturing process according to the above-mentioned present disclosure (hereinafter, this is expressed also as “polyamide solution according to the present disclosure”). The solvent in the polyamide solution according to the present disclosure may be the solvent used during the synthesis, or it may be the solvent used in the re-dissolution.

[Content of Polyamide]

In one or a plurality of embodiments, the content of the polyamide in the polyamide solution according to the present disclosure may be 2% by weight or more, 3% by weight or more, or, 5% by weight or more from the viewpoint of use of the film for a display element, an optical element, an illumination element or a sensor element. From a similar viewpoint, it may be 30% by weight or less, 20% by weight or less, or, 15% by weight or less.

In one or a plurality of embodiments, the polyamide solution according to the present disclosure may contain inorganic filler.

In one or a plurality of embodiments, the polyamide solution according to the present disclosure is a polyamide solution to be used in a process for manufacturing a display element, an optical element, an illumination element or a sensor element.

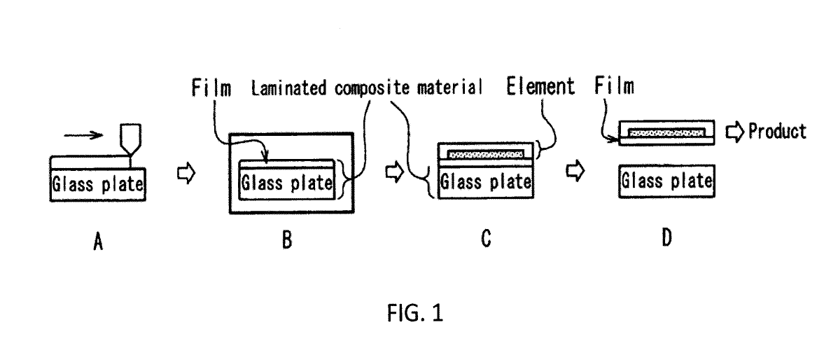

A display element, an optical element, or an illumination element such as an organic electro-luminescence (OEL) or organic light-emitting diode (OLED) is often produced by the method as described in FIG. 1. Briefly, a polymer solution (varnish) is applied or casted on a glass base or a silicon wafer base (step A), the applied polymer solution is cured to form a film (step B), an element such as OLED is formed on the film (step C), and then, the element such as OLED (product) is de-bonded from the base (step D). In one or a plurality of embodiments, the polyamide solution according to the present disclosure can be used as the polymer solution (vanish).

[Process for Manufacturing Display Element, Optical Element, Illumination Element or Sensor Element]

Therefore, in another aspect, the present disclosure relates to a process for manufacturing a display element, an optical element, an illumination element or a sensor element, including the steps (I) and (II) below (hereinafter, this is expressed also as “process for manufacturing an element according to the present disclosure”).

(I) applying a polyamide solution on a base so as to form a film, the solution being obtained or obtainable by the process according to the present disclosure; and

(II) forming the display element, the optical element, the illumination element, or the sensor element on the surface of the polyamide film;

wherein the base or the surface of the base is formed of glass or silicon wafer.

In one or a plurality of embodiments, the process for manufacturing an element according to the present disclosure includes further a step of de-bonding the thus formed display element, optical element, illumination element or sensor element from the base.

[Laminated Composite Material]

The term “laminated composite material” as used herein refers to a material in which a base and a polyamide resin layer are laminated. In one or a plurality of non-limiting embodiments, a base and a polyamide resin layer being laminated indicates that the base and the polyamide resin layer are laminated directly. Alternatively, in one or a plurality of non-limiting embodiments, it indicates that the base and the polyamide resin layer are laminated via one or a plurality of layers.

In one or a plurality of non-limiting embodiments, the laminated composite material can be used in a process for manufacturing a display element, an optical element, an illumination element or a sensor element, such as the one illustrated in FIG. 1. Further in one or a plurality of non-limiting embodiments, it can be used as a laminated composite material obtained in the step B of the manufacturing process illustrated in FIG. 1. Therefore, in another aspect, the present disclosure relates to a laminated composite material including a polyamide resin layer laminated on one surface of a glass plate, wherein the polyamide resin of the polyamide resin layer is formed by the manufacturing process according to the present disclosure.

In one or a plurality of embodiments, the laminated composite material according to the present disclosure is a laminated composite material to be used for a process for manufacturing a display element, an optical element, an illumination element or a sensor element, the process including formation of a display element, an optical element or an illumination element, or a sensor element on a surface of the polyamide resin layer which is opposite to the surface facing the glass plate.

In one or a plurality of embodiments, the laminated composite material according to the present disclosure may include additional organic resin layers and/or inorganic layers in addition to the polyamide resin layer. In one or a plurality of non-limiting embodiments, examples of additional organic resin layers include a flattened coat layer. Further, in one or a plurality of non-limiting embodiments, examples of inorganic layers include a gas barrier layer capable of suppressing permeation of water or oxygen and a buffer coat layer capable of suppressing migration of ions to a TFT element.

[Thickness of Polyamide Resin Layer]

In one or a plurality of embodiments, from the viewpoint of using the film in a display element, an optical element, an illumination element or a sensor element and suppressing the development of cracks in the resin layer, the polyamide resin layer of the laminated composite material according to the present disclosure has a thickness of 500 μm or less, 200 μm or less, or 100 μm or less. Further, in one or a plurality of non-limiting embodiments, the polyamide resin layer has a thickness of 1 μm or more, 2 μm or more, or 3 μm or more, for example.

[Transmittance of Polyamide Resin Layer]

In one or a plurality of embodiments, the polyamide resin layer of the laminated composite material according to the present disclosure has a total light transmittance of 70% or more, 75% or more, or 80% or more from the viewpoint of allowing the laminated composite material to be used suitably in manufacturing a display element, an optical element, an illumination element or a sensor element.

[Base]

In one or a plurality of embodiments, from the viewpoint of using the film in a display element, an optical element, an illumination element or a sensor element, the material of the base of the laminated composite material according to the present disclosure may be, for example, glass, soda-lime glass, non-alkali glass, silicon wafer or the like. In one or a plurality of embodiments, from the viewpoint of using the film in a display element, an optical element, an illumination element or a sensor element, the base of the laminated composite material according the present disclosure has a thickness of 0.3 mm or more, 0.4 mm or more, or 0.5 mm or more. Further, in one or a plurality of embodiments, the base has a thickness of 3 mm or less or 1 mm or less, for example.

[Process for Manufacturing Laminated Composite Material]

In one or a plurality of non-limiting embodiments, the laminated composite material according to the present disclosure can be manufactured by applying the polyamide solution according to the present disclosure on a glass plate, and drying, and if necessary curing, the applied solution. Therefore, in one or a plurality of embodiments of the present disclosure, the present disclosure relates to a process for manufacturing the laminated composite material including the steps of

i) applying a solution of aromatic polyamide on a base; and

ii) heating the casted polyamide solution to form a polyamide film after the step (a).

In one or a plurality of embodiments, the process for manufacturing an element according to the present disclosure is a manufacturing process including a step of forming a display element, an optical element, or an illumination element or a sensor element on a surface of the polyamide resin layer of the laminated composite material according to the present disclosure, i.e., a surface opposite to the surface facing the glass plate. In one or a plurality of embodiments, the manufacturing process further includes the step of de-bonding the thus formed display element, the optical element, the illumination element or the sensor element from the glass plate.

[Display Element, Optical Element, or Illumination Element]

The term “a display element, an optical element, or an illumination element” as used in the present disclosure refers to an element that constitutes a display (display device), an optical device, or an illumination device, and examples of such elements include an organic EL element, a liquid crystal element, and organic EL illumination. Further, the term also covers a component of such elements, such as a thin film transistor (TFT) element, a color filter element or the like. In one or a plurality of embodiments, the display element, the optical element or the illumination element according to the present disclosure includes what is manufactured by using the polyamide solution according to the present disclosure, and/or what is manufactured by using the laminated composite material according to the present disclosure, and/or what is manufactured by the process for manufacturing an element according to the present disclosure.

<Non-Limiting Embodiment of Organic EL Element>

Hereinafter, one embodiment of an organic EL element as one embodiment of the display element according to the present disclosure will be described with reference to the drawing.

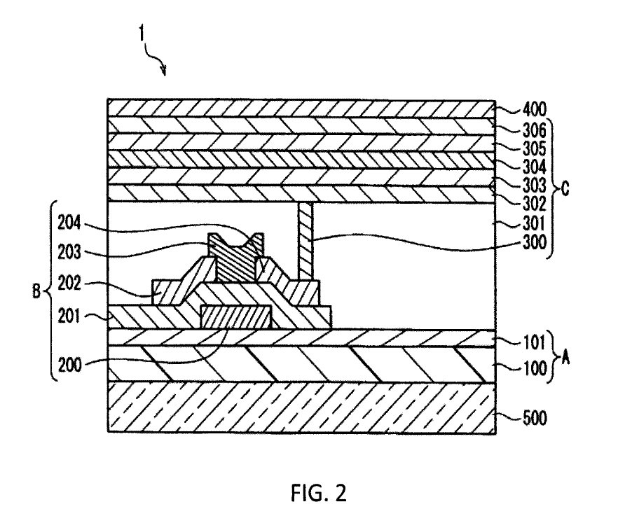

FIG. 2 is a schematic cross-sectional view showing an organic EL element 1 according to one embodiment. The organic EL element 1 includes a thin film transistor B formed on a substrate A and an organic EL layer C. Note that the organic EL element 1 is entirely covered with a sealing member 400. The organic EL element 1 may be separated from a base 500 or may include the base 500. Hereinafter, each component will be described in detail.

1. Substrate A

The substrate A includes a transparent resin substrate 100 and a gas barrier layer 101 formed on top of the transparent resin substrate 100. Here, the transparent resin substrate 100 is a film formed from a polyamide solution according to the present disclosure. The transparent resin substrate 100 may have been annealed by heat. Annealing is effective in, for example, removing distortions and in improving the size stability against environmental changes.

The gas barrier layer 101 is a thin film made of SiOx, SiNx or the like, and is formed by a vacuum film formation method such as sputtering, CVD, vacuum deposition or the like. Generally, the gas barrier layer 101 has a thickness of, but is not limited to, about 10 nm to 100 nm. Here, the gas barrier layer 101 may be formed on a surface of the transparent resin substrate 100 facing the gas barrier layer 101 in FIG. 2 or may be formed on the both surfaces of the transparent resin substrate 100.

2. Thin Film Transistor

The thin film transistor B includes a gate electrode 200, a gate insulating film 201, a source electrode 202, an active layer 203, and a drain electrode 204. The thin film transistor B is formed on the gas barrier layer 101.

The gate electrode 200, the source electrode 202, and the drain electrode 204 are transparent thin films made of indium tin oxide (ITO), indium zinc oxide (IZO), zinc oxide (ZnO), or the like. For example, sputtering, vacuum deposition, ion plating or the like may be used to form these transparent thin films. Generally, these electrodes have a film thickness of, but is not limited to, about 50 nm to 200 nm.

The gate insulating film 201 is a transparent insulating thin film made of SiO₂, Al₂O₃ or the like, and is formed by sputtering, CVD, vacuum deposition, ion plating or the like. Generally, the gate insulating film 201 has a film thickness of, but is not limited to, about 10 nm to 1 μm.

The active layer 203 is a layer of, for example, single crystal silicon, low temperature polysilicon, amorphous silicon, or oxide semiconductor, and a material best suited to the active layer 203 is used as appropriate. The active layer is formed by sputtering or the like.

3. Organic EL layer

The organic EL layer C includes a conductive connector 300, an insulative flattened layer 301, a lower electrode 302 as the anode of the organic EL element 1, a hole transport layer 303, a light-emitting layer 304, an electron transport layer 305, and an upper electrode 306 as the cathode of the organic EL element 1. The organic EL layer C is formed at least on the gas barrier layer 101 or on the thin film transistor B, and the lower electrode 302 and the drain electrode 204 of the thin film transistor B are connected to each other electrically through the connector 300. Instead, the lower electrode 302 and the source electrode 202 of the thin film transistor B may be connected to each other through the connector 300.

The lower electrode 302 is the anode of the organic EL element 1, and is a transparent thin film made of indium tin oxide (ITO), indium zinc oxide (IZO), zinc oxide (ZnO) or the like. ITO is preferred because, for example, high transparency, and high conductivity can be achieved.

For the hole transport layer 303, the light-emitting layer 304, and the electron transport layer 305, conventionally-known materials for organic EL elements can be used as is.

The upper electrode 306 is a film composed of a layer of lithium fluoride (LiF) having a film thickness of 5 nm to 20 nm and a layer of aluminum (Al) having a film thickness of 50 nm to 200 nm. For example, vacuum deposition may be use to form the film.

When producing a bottom emission type organic EL element, the upper electrode 306 of the organic EL element 1 may be configured to have optical reflectivity. Thereby, the upper electrode 306 can reflect, in the display side direction, light generated by the organic EL element A and traveled toward the upper side as the opposite direction to the display side. Since the reflected light is also utilized for a display purpose, the emission efficiency of the organic EL element can be improved.

<Non-limiting Embodiment of Process of Manufacturing Organic EL Element>

As one embodiment of the process of manufacturing a display element according to the present disclosure, hereinafter, one embodiment of a process of manufacturing an organic EL element will be described with reference to the drawing.

A method of producing the organic EL element 1 shown in FIG. 2 includes a fixing step, a gas barrier layer production step, a thin film transistor production step, an organic EL layer production step, a sealing step and a de-bonding step. Hereinafter, each step will be described in detail.

1. Fixing Step

In the fixing step, the transparent resin substrate 100 is fixed onto the base 500. Away to fix the transparent resin substrate to the base is not particularly limited. For example, an adhesive may be applied between the base 500 and the transparent resin substrate 100, or a part of the transparent resin substrate 100 may be fused and attached to the base 500 to fix the transparent resin substrate 100 to the base 500. Further, as the material of the base, glass, metal, silicon, resin or the like is used, for example. These materials may be used alone or in combination of two or more as appropriate. Furthermore, the transparent resin substrate 100 may be attached to the base 500 by applying a releasing agent or the like on the base 500 and placing the transparent resin substrate 100 on the applied releasing agent. In one or a plurality of embodiments, the polyamide film 100 is formed by applying the polyamide solution according to the present disclosure on the base 500, and for example drying the applied solution.

2. Gas Barrier Layer Production Step

In the gas barrier layer production step, the gas barrier layer 101 is produced on the transparent resin substrate 100. Away to produce the gas barrier layer 101 is not particularly limited, and a known method can be used.

3. Thin Film Transistor Production Step

In the thin film transistor production step, the thin film transistor B is produced on the gas barrier layer. A way to produce the thin film transistor B is not particularly limited, and a known method can be used.

4. Organic EL Layer Production Step

The organic EL layer production step includes a first step and a second step. In the first step, the flattened layer 301 is formed. The flattened layer 301 can be formed by, for example, spin-coating, slit-coating, or ink-jetting a photosensitive transparent resin. At that time, an opening needs to be formed in the flattened layer 301 so that the connector 300 can be formed in the second step. Generally, the flattened layer has a film thickness of, but is not limited to, about 100 nm to 2 μm.

In the second step, first, the connector 300 and the lower electrode 302 are formed at the same time. Sputtering, vacuum deposition, ion plating or the like may be used to form the connector 300 and the lower electrode 302. Generally, each of these electrodes has a film thickness of, but is not limited to, about 50 nm to 200 nm. Subsequently, the hole transport layer 303, the light-emitting layer 304, the electron transport layer 305, and the upper electrode 306 as the cathode of the organic EL element 1 are formed. To form these components, a method such as vacuum deposition, application, or the like can be used as appropriate in accordance with the materials to be used and the laminate structure. Further, irrespective of the explanations given in this example, other layers may be chosen from known organic layers such as a hole injection layer, an electron transport layer, a hole blocking layer and an electron blocking layer as needed and be used to configuring the organic layers of the organic EL element 1.

5. Sealing Step

In the sealing step, the organic EL layer C is sealed with the sealing member 307 from top of the upper electrode 306. For example, a glass material, a resin material, a ceramics material, a metal material, a metal compound or a composite thereof can be used to form the sealing member 307, and a material best suited to the sealing member 307 can be chosen as appropriate.

6. De-Bonding Step

In the de-bonding step, the produced organic EL element 1 is de-bonded from the base 500. To implement the de-bonding step, for example, the organic EL element 1 may be physically stripped from the base 500. At that time, the base 500 may be provided with a de-bonding layer, or a wire may be inserted between the base 500 and the display element to remove the organic EL element. Further, examples of other methods of de-bonding the organic EL element 1 from the base 500 include the following: forming a de-bonding layer on the base 500 except at ends, and cutting, after the production of the element, the inner part from the ends to remove the element from the base; providing a layer of silicon or the like between the base 500 and the element, and irradiating the silicon layer with a laser to strip the element; applying heat to the base 500 to separate the base 500 and the transparent substrate from each other; and removing the base 500 using a solvent. These methods may be used alone or any of these methods may be used in combination of two or more. Especially in one or a plurality of embodiments, the strength of adhesion between the polyamide film and the base can be controlled by a silane coupling agent, so that the organic EL element 1 can be physically stripped without using the complicated method such as described above.

[Display Device, Optical Device, and Illumination Device]

An aspect of the present disclosure relates to a display device, an optical device, or an illumination device using the display element, the optical element, or the illumination element according to the present disclosure, or a process of manufacturing the display device, the optical device, or the illumination device. Examples of the display device include, but are not limited to, an imaging element; examples of the optical device include, but are not limited to, a photoelectric complex circuit; and examples of the illumination device include, but are not limited to, a TFT-LCD and OEL illumination.

[Sensor Element]

In the present disclosure, “sensor element” refers to a sensor element that can be used in an input device. In one or a plurality of non-limiting embodiments, examples of the “sensor element” include a sensor element for electromagnetic wave, or a sensor element for magnetic field, examples of which include an image pickup element, a radiation sensor element, a photo sensor element, and a magnetic sensor element. In one or a plurality of embodiments, examples of the radiation sensor element include an X-ray sensor element. In one or a plurality of embodiments, the sensor element according to the present disclosure includes a sensor element that is manufactured by using the polyamide solution according to the present disclosure, and/or a sensor element that is manufactured by using the laminated composite material according to the present disclosure, and/or a sensor element that is manufactured by the process for manufacturing an element according to the present disclosure. Further, in one or a plurality of embodiments, forming of the sensor element according to the present disclosure includes forming of a photoelectric conversion element and a driver element.

[Input Device]

In the present disclosure, in one or a plurality of embodiments, examples of an input device using the “sensor element” include an optical input device, an image pickup input device, and a magnetic input device. In one or a plurality of non-limiting embodiments, examples of the input device include a radiation image pickup device, a visible light image pickup device, and a magnetic sensor device. In one or a plurality of embodiments, examples of the radiation image pickup device include an X-ray pickup device. Further, in one or a plurality of non-limiting embodiments, an input device according to the present disclosure may have a function of an output device such as display function. Therefore, in one aspect, the present disclosure relates to an input device using a sensor element manufactured by the manufacturing method in this aspect, and also relates to a method for manufacturing the same.

<Non-Limiting Embodiment for Sensor Element>

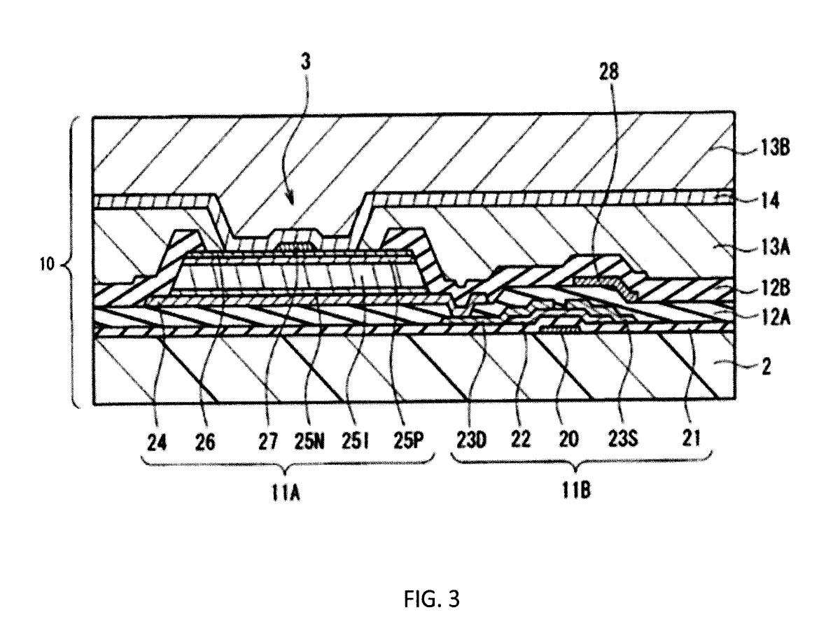

Hereinafter, an embodiment of sensor element that can be manufactured by the manufacturing method in this aspect are explained with reference to FIG. 3.

FIG. 3 is a schematic cross-sectional view showing a sensor element 10 according to an embodiment. The sensor element 1 has a plurality of pixels. This sensor element 1 is produced by forming, on a surface of a substrate 2, a pixel circuit including a plurality of photodiodes 11A (photoelectric conversion element) and a thin film transistor (TFT) 11B as the driver element for the photodiodes 11A. This substrate 2 is the polyamide film to be formed on a base (not shown) by the step (A) of the manufacturing method in this aspect. And in the step (B) of the manufacturing method in this aspect, the photodiodes 11A (photoelectric conversion element) and the thin film transistor 11B as the driver element for the photodiodes 11A are formed.

A gate insulating film 21 is provided on the substrate 2, and it is composed of a single layer film of any one of a silicon oxide (SiO₂) film, a silicon oxynitride (SiON) film and a silicon nitride (SiN) film for example, or a laminated film of two or more of them. A first interlayer insulating film 12A is provided on the gate insulating film 21, and it is composed of a silicon oxide film or a silicon nitride film etc. This first interlayer insulating film 12A functions also as a protective film (passivation film) to cover the top of the thin film transistor 11B described below.

(Photodiode 11A)

The photodiode 11A is disposed on a selective region of the substrate 2 via the gate insulating film 21 and the first interlayer insulating film 12A. Specifically, the photodiode 11A is prepared by laminating, on the first interlayer insulating film 12A, a lower electrode 24, a n-type semiconductor layer 25N, an i-type semiconductor layer 251, a p-type semiconductor layer 25P and an upper electrode 26 in this order. The upper electrode 26 is an electrode for supplying a reference potential (bias potential) during a photoelectric conversion for example to the above-mentioned photoelectric conversion layer, and thus it is connected to a wiring layer 27 as a power supply wiring for supplying the reference potential. This upper electrode 26 is composed of a transparent conductive film of ITO (indium tin oxide) or the like, for example.

(Thin Film Transistor 11B)

The thin film transistor 11B is composed of a field effect transistor (FET), for example. This thin film transistor 11B is prepared by forming on the substrate 2 a gate electrode 20 composed of titanium (Ti), Al, Mo, tungsten (W), chromium (Cr) and the like, and by forming the above-mentioned gate insulating film 21 on this gate electrode 20. Further, a semiconductor layer 22 is formed on the gate insulating film 21, and the semiconductor layer 22 has a channel region. On this semiconductor layer 22, a source electrode 23S and a drain electrode 23D are formed. Specifically, here, the drain electrode 23D is connected to the lower electrode 24 in each photodiode 11A while the source electrode 23S is connected to a relay electrode 28.

Furthermore in the sensor element 1, on such photodiode 11A and the thin film transistor 11B, a second interlayer insulating film 12B, a first flattened film 13A, a protective film 14 and a second flattened film 13B are provided in this order. Further in this first flattened film 13A, an opening 3 is formed corresponding to the region for forming the photodiode 11A.

On the sensor element 1, for example, a wavelength conversion member is formed to produce a radiograph device.

Regarding the above-mentioned embodiments, the present disclosure further discloses compositions, manufacturing processes and applications below.

<1> A process for manufacturing polyamide, comprising steps of:

(a) dissolving diacid dichloride in a non-amide-based organic solvent;

(b) adding diamine to a solution obtained by the step (a) and reacting the diacid dichloride with the diamine so as to generate polyamide; and

(c) adding a trapping reagent capable of trapping hydrochloric acid, at any time at least before the step (b), at the same time of starting the step (b), or during the step (b).

<2> The process according to <1>, wherein the non-amide-based organic solvent is a non-protic solvent.
<3> The process according to <1> or <2>, wherein the non-amide-based organic solvent is γ-butyrolactone, α-methyl-γ-butyrolactone, or a mixture thereof
<4> The process according to any one of <1> to <3>, wherein the polyamide is obtained as a polyamide solution where the polyamide is dissolved in a solvent.
<5> The process according to any one of <1> to <4>, wherein the trapping agent is propylene oxide.
<6> The process according to any one of <1> to <5>, wherein the diacid dichloride is selected from the group consisting of:

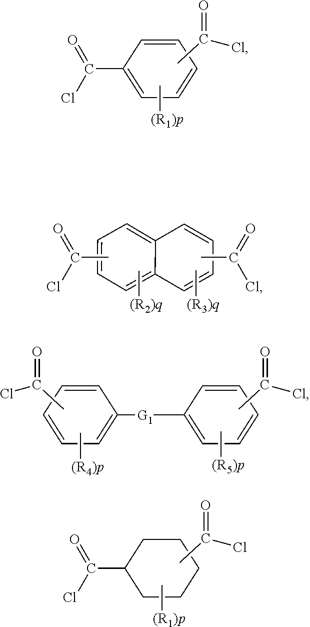

and a combination thereof,

wherein p=4, q=3, and wherein R₁, R₂, R₃, R₄, and R₅ are selected from the group consisting of hydrogen, halogen, alkyl, substituted alkyl, nitro, cyano, thioalkyl, alkoxy, substituted alkoxy, aryl, substituted aryl, alkyl ester, substituted alkyl ester, and combinations thereof;

wherein G₁ is selected from the group consisting of a covalent bond; a CH₂ group; a C(CH₃)₂ group; a C(CF₃)₂ group; a C(CX₃)₂ group, where X is a halogen; a CO group; an O atom; a S atom; a SO₂ group; a Si(CH₃)₂ group; a 9,9-fluorene group; a substituted 9,9-fluorene group; and an OZO group, where Z is an aryl group or a substituted aryl group.

<7> The process according to any one of <1> to <6>, wherein the diacid dichloride is selected from the group consisting of terephthaloyl dichloride, isophthaloyl dichloride, 2,6-naphthaloyl dichloride, 4,4′-biphenyldicarbonyl dichloride, tetrahydro terephthaloyl dichloride and a combination thereof.
<8> The process according to any one of <1> to <7>, wherein the diamine is selected from the group consisting of:

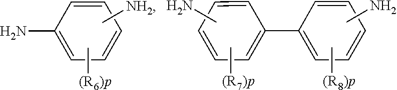

and a combination thereof,

wherein p=4, and wherein R₆, R₇, and R₈ are selected from the group consisting of hydrogen, halogen, alkyl, substituted alkyl, nitro, cyano, thioalkyl, alkoxy, substituted alkoxy, aryl, substituted aryl, alkyl ester, substituted alkyl ester, and combinations thereof;

wherein G₂ is selected from the group consisting of a covalent bond; a CH₂ group; a C(CH₃)₂ group; a C(CF₃)₂ group; a C(CX₃)₂ group, where X is a halogen; a CO group; an O atom; a S atom; a SO₂ group; a Si(CH₃)₂ group; a 9,9-fluorene group; a substituted 9,9-fluorene group; and an OZO group, where Z is an aryl group or a substituted aryl group.

<9> The process according to any one of <1> to <8>, wherein the diamine is selected from the group consisting of 4,4′-diamino-2,2′-bistrifluoromethylbenzidine, 9,9-bis(4-aminophenyl) fluorene, 9,9-bis(3-fluoro-4-aminophenyl)fluorene, 2,2′-bistrifluoromethoxylbenzidine, 4,4′-diamino-2,2′-bistrifluoromethyldiphenyl ether, bis(4-amino-2-trifluoromethylphenyloxyl)benzene, bis(4-amino-2-trifluoromethylphenyloxyl)biphenyl, bis(4-aminophenyl) sulfone (DDS), and a combination thereof.
<10> The process according to any one of <1> to <9>, wherein the steps (a) and (b) are conducted in the absence of an amide-based organic solvent.
<11> A polyamide solution manufactured by the process according to any one of <1> to <10>.
<12> A process for manufacturing a display element, an optical element, an illumination element or a sensor element, comprising steps of

(I) applying a polyamide solution on a base to form a film, the solution being obtained or obtainable by the process according to any one of <1> to <10>; and

(II) forming the display element, the optical element, the illumination element, or the sensor element on a surface of the polyamide film;

wherein the base or the surface of the base is formed of glass or silicon wafer.

<13> The process according to <12>, further comprising a step of de-bonding the formed display element, the optical element, the illumination element or the sensor element from the base.

### EXAMPLES

### Example 1

Based on the above-described process for manufacturing polyamide, this Example indicates a procedure of manufacturing a polyamide solution from diacid dichloride (TPC, IPC) and diamine (PFMB) by using a non-amide-based solvent as the solvent and propylene oxide as the hydrochloric acid trapping agent.

To a 5 L three necked round bottom flask, equipped with a mechanical stirrer, a nitrogen inlet and outlet, were added IPC (149.8 g, 0.74 mol), TPC (16.65 g, 0.08 mol) and GBL (3.2 L, 4.4.kg). After the IPC and the TPC were dissolved completely, PrO (143 g, 2.46 mol) was added and the materials were stirred. Next, under nitrogen, PFMB (247.4 g, 0.77 ml) was added to the diacid dichloride solution mixed with PrO and the wall of the flask was washed away with GBL (4 nil, 4.5 g). The viscosity of the solution increased gradually. The solution did not become whitish. After stirring further 20 hours at room temperature, it was confirmed that the increase in viscosity had stopped, and the stirring was finished. The obtained reaction solution did not colored yellowish. The obtained reaction solution was introduced into a large excess methanol, and the deposited precipitation was collected by filtering. The precipitation was washed with methanol, and dried sufficiently to obtain a polymer.

The embodiments have been described, hereinabove. It will be apparent to those skilled in the art that the above methods and apparatuses may incorporate changes and modifications without departing from the general scope of the present disclosure. It is intended to include all such modifications and alterations insofar as they come within the scope of the appended claims or the equivalents thereof. Although the description above contains much specificity, this should not be construed as limiting the scope of the disclosure, but as merely providing illustrations of some of the embodiments of the present disclosure. Various other embodiments and ramifications are possible within its scope.

Furthermore, notwithstanding that the numerical ranges and parameters setting forth the broad scope of the disclosure are approximations, the numerical values set forth in the specific examples are reported as precisely as possible. Any numerical value, however, inherently contain certain errors necessarily resulting from the standard deviation found in their respective testing measurements.

What is claimed is:

1. A process for manufacturing polyamide, comprising steps of:
(a) dissolving diacid dichloride in a non-amide-based organic solvent;
(b) adding diamine to a solution obtained by the step (a) and reacting the diacid dichloride with the diamine so as to generate polyamide; and
(c) adding a trapping reagent capable of trapping hydrochloric acid, at any time at least before the step (b), at the same time of starting the step (b), or during the step (b).

2. The process according to claim 1, wherein the non-amide-based organic solvent is a non-protic solvent.

3. The process according to claim 1, wherein the non-amide-based organic solvent is γ-butyrolactone, α-methyl-γ-butyrolactone, or a mixture thereof.

4. The process according to claim 1, wherein the polyamide is obtained as a polyamide solution where the polyamide is dissolved in a solvent.

5. The process according to claim 1, wherein the trapping agent is propylene oxide.

6. The process according to claim 1, wherein the diacid dichloride is selected from the group consisting of: 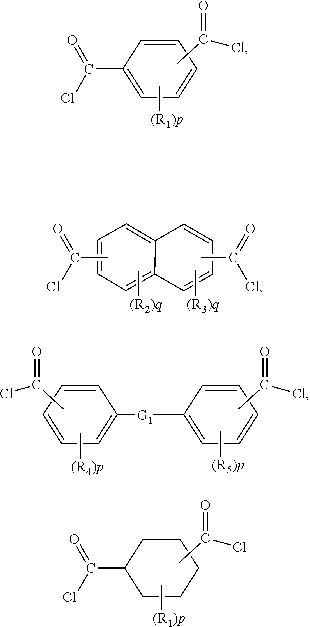
and a combination thereof,
wherein p=4, q=3, and wherein R₁, R₂, R₃, R₄, and R₅ are selected from the group consisting of hydrogen, halogen, alkyl, substituted alkyl, nitro, cyano, thioalkyl, alkoxy, substituted alkoxy, aryl, substituted aryl, alkyl ester, substituted alkyl ester, and combinations thereof;
wherein G₁ is selected from the group consisting of a covalent bond; a CH₂ group; a C(CH₃)₂ group; a C(CF₃)₂ group; a C(CX₃)₂ group, where X is a halogen; a CO group; an O atom; a S atom; a SO₂ group; a Si(CH₃)₂ group; a 9,9-fluorene group; a substituted 9,9-fluorene group; and an OZO group, where Z is an aryl group or a substituted aryl group.

7. The process according to claim 1, wherein the diacid dichloride is selected from the group consisting of terephthaloyl dichloride, isophthaloyl dichloride, 2,6-naphthaloyl dichloride, 4,4′-biphenyldicarbonyl dichloride, tetrahydro terephthaloyl dichloride and a combination thereof.

8. The process according to claim 1, wherein the diamine is selected from the group consisting of: 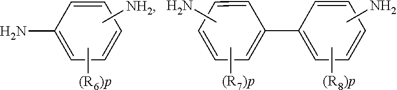
and a combination thereof,
wherein p=4, and wherein R₆, R₇, and R₈ are selected from the group consisting of hydrogen, halogen, alkyl, substituted alkyl, nitro, cyano, thioalkyl, alkoxy, substituted alkoxy, aryl, substituted aryl, alkyl ester, substituted alkyl ester, and combinations thereof;
wherein G₂ is selected from the group consisting of a covalent bond; a CH₂ group; a C(CH₃)₂ group; a C(CF₃)₂ group; a C(CX₃)₂ group, where X is a halogen; a CO group; an O atom; a S atom; a SO₂ group; a Si(CH₃)₂ group; a 9,9-fluorene group; a substituted 9,9-fluorene group; and an OZO group, where Z is an aryl group or a substituted aryl group.

9. The process according to claim 1, wherein the diamine is selected from the group consisting of 4,4′-diamino-2,2′-bistrifluoromethylbenzidine, 9,9-bis(4-aminophenyl) fluorene, 9,9-bis(3-fluoro-4-aminophenyl) fluorene, 2,2′-bistrifluoromethoxylbenzidine, 4,4′-diamino-2,2′-bistrifluoromethyldiphenyl ether, bis(4-amino-2-trifluoromethylphenyloxyl)benzene, bis(4-amino-2-trifluoromethylphenyloxyl)biphenyl, bis(4-aminophenyl)sulfone (DDS), and a combination thereof.

10. The process according to claim 1, wherein the steps (a) and (b) are conducted in the absence of an amide-based organic solvent.

11. A polyamide solution manufactured by the process according to claim 1.

12. A process for manufacturing a display element, an optical element, an illumination element or a sensor element, comprising steps of:
(I) applying a polyamide solution on a base to form a film, the solution being obtained or obtainable by the process according to claim 1; and
(II) forming the display element, the optical element, the illumination element, or the sensor element on a surface of the polyamide film;
wherein the base or the surface of the base is formed of glass or silicon wafer.

13. The process according to claim 12, further comprising a step of de-bonding the formed display element, the optical element, the illumination element or the sensor element from the base.
